(19) United States
(12) Patent Application Publication
(10) Pub. No.: US 2024/0186553 A1
(43) Pub. Date: Jun. 6, 2024

(54) Benzimidazole-Based Polymer Electrolyte Membrane Having High Ionic Conductivity Under High Temperature and Non-Humidified Conditions and Method for Preparing Same

(71) Applicants: Hyundai Motor Company, Seoul (KR); Kia Corporation, Seoul (KR); Industrial Cooperation Foundation Jeonbuk National University, Jeonju-si (KR)

(72) Inventors: Il Seok Chae, Seoul (KR); Sung Kon Kim, Jeonju-si (KR); Hyun Jun Kim, Gwangju (KR); Min Guk Gu, Daejeon (KR)

(21) Appl. No.: 18/235,024

(22) Filed: Aug. 17, 2023

(30) Foreign Application Priority Data
Nov. 17, 2022 (KR) 10-2022-0154781

(51) Int. Cl. H01M 8/103; H01M 8/1004; H01M 8/1072; H01M 8/1081

(52) U.S. Cl. CPC H01M 8/103; H01M 8/1004; H01M 8/1072; H01M 8/1081; H01M 2008/1095

(57) ABSTRACT

An embodiment method for preparing a polymer electrolyte membrane includes preparing a nanostructure including an imidazole group, mixing a benzimidazole-based polymer, the nanostructure, and a crosslinking agent including an isocyanate group to prepare a mixture, and forming the mixture in a form of a film. An embodiment fuel cell includes a polymer electrolyte membrane including a reaction product of a benzimidazole-based polymer, a nanostructure including an imidazole group, and a crosslinking agent including an isocyanate group, a cathode on a first surface of the polymer electrolyte membrane, and an anode on a second surface of the polymer electrolyte membrane opposite the first surface.

### CROSS-REFERENCE TO RELATED APPLICATIONS

This application claims the benefit of Korean Patent Application No. 10-2022-0154781, filed on Nov. 17, 2022, which application is hereby incorporated herein by reference.

### TECHNICAL FIELD

The present disclosure relates to a benzimidazole-based polymer electrolyte membrane and a method for preparing the same.

### BACKGROUND

Currently, the most widely used polymer electrolyte membranes include Nafion, which is a perfluorinated electrolyte membrane manufactured by Dupont, and a perfluorinated electrolyte membrane having a porous filled membrane structure manufactured by Gore. All are characterized by having a perfluorinated polymer structure. The perfluorinated electrolyte membrane has advantages such as high ionic conductivity, high chemical stability, and the like, but there are disadvantages in that the unit price is high due to a complicated preparation process, and hydrofluoric acid and fluorine-based contaminants are released during the decomposition process. Therefore, it is necessary to develop a hydrocarbon-based polymer electrolyte membrane.

In particular, the number of polymer electrolyte membranes that can be applied to fuel cells that can be driven at high temperatures is limited due to problems with the durability of the polymer and the ion transport mechanism. Among them, a hydrocarbon-based polymer electrolyte membrane in the form of benzimidazole, which may contain phosphoric acid, is in the spotlight.

Meanwhile, a benzimidazole-based polymer electrolyte membrane has been reported through various literatures, but when the phosphoric acid content in the benzimidazole-based polymer electrolyte membrane increases, the hydrogen ion conductivity increases, but there are problems such as deterioration of mechanical properties and elution of phosphoric acid. On the other hand, the benzimidazole-based polymer electrolyte membrane has a problem in that current density is lowered due to the decrease in hydrogen ion conductivity when the phosphoric acid content is low.

### SUMMARY

Embodiments of the present disclosure provide a benzimidazole-based polymer electrolyte membrane that can satisfy all of hydrogen ion conductivity, durability, mechanical properties, and price while maintaining a high phosphoric acid content under high temperature conditions, and a method for preparing the same.

The embodiments of the present disclosure are not limited to the embodiments mentioned above. The embodiments of the present disclosure will become more apparent from the following description and will be realized by means and combinations thereof described in the claims.

A polymer electrolyte membrane according to embodiments of the present disclosure is obtained by reacting a benzimidazole-based polymer, a nanostructure containing an imidazole group, and a crosslinking agent containing an isocyanate group.

The polymer electrolyte membrane may be one in which an imidazole group in the benzimidazole-based polymer and the imidazole group in the nanostructure are crosslinked by the isocyanate group.

The polymer electrolyte membrane may include urea crosslinking.

The benzimidazole-based polymer may include at least one selected from the group consisting of poly[2,2′-(m-phenylene)-5,5′-bibenzimidazole] (PBI), poly(2,5-benzimidazole) (ABPBI), and a combination thereof.

The nanostructure may be one in which any one selected from the group consisting of Zn, Co, Cu, Fe, and combinations thereof is connected to imidazole or an imidazole derivative.

The nanostructure may be a zeolitic imidazolate framework (ZIF) having a particle size of 100 nm or less.

The crosslinking agent may include any one selected from the group consisting of methylene diphenyl diisocyanate (MDI), hexamethylene diisocyanate (HDI), and a combination thereof.

The crosslinking agent may have 2 to 4 functional groups.

The polymer electrolyte membrane may further include an amine-based catalyst, and the amine-based catalyst may include any one selected from triethylamine (TEA), tripropylamine, polyisopropanolamine, tributylamine, trioctylamine, hexamethyldimethylamine, N-methylmorpholine, N-ethylmorpholine, N-octadecylmorpholine, monoethanolamine, diethanolamine, triethanolamine, N-methyldiethanolamine, N,N-dimethylethanolamine, diethylenetriamine, N,N,N′,N′-tetramethylethylenediamine, N,N,N′,N′-tetramethylpropylenediamine, N,N,N′,N′-tetramethylbutanediamine, N,N,N′,N′-tetramethyl-1,3-butanediamine, N,N,N′,N′-tetramethylhexamethylenediamine, bis[2-(N,N-dimethylamino)ethyl] ether, N,N-dimethylbenzylamine, N,N-dimethylcyclohexylamine, N,N,N′,N″,N″′-pentamethyldiethylenetriamine, and triethylenediamine.

Furthermore, a fuel cell according to embodiments of the present disclosure includes the polymer electrolyte membrane, a cathode positioned on one surface of the polymer electrolyte membrane, and an anode positioned on the other surface of the polymer electrolyte membrane.

Furthermore, a method for preparing a polymer electrolyte membrane according to embodiments of the present disclosure includes steps of preparing a nanostructure containing an imidazole group, mixing a benzimidazole-based polymer, the nanostructure, and a crosslinking agent containing an isocyanate group to prepare a mixture, and forming the mixture in the form of a film.

In the step of preparing a nanostructure, the nanostructure may be obtained by drying the mixture after mixing a compound including any one selected from the group consisting of imidazole or an imidazole derivative, Zn, Co, Cu, Fe, and combinations thereof, and a solvent.

The nanostructure may be a zeolitic imidazolate framework (ZIF) having a particle size of 100 nm or less.

In the step of preparing the mixture, the benzimidazole-based polymer and the crosslinking agent may be mixed at a weight ratio of 100:0 to 50:50.

The benzimidazole-based polymer may include at least one selected from the group consisting of poly[2,2′-(m-phenylene)-5,5′-bibenzimidazole] (PBI), poly(2,5-benzimidazole) (ABPBI), and a combination thereof.

The crosslinking agent may include any one selected from the group consisting of methylene diphenyl diisocyanate (MDI), hexamethylene diisocyanate (HDI), and a combination thereof.

In the step of preparing the mixture, the benzimidazole-based polymer and the nanostructure may be mixed at a weight ratio of 100:0 to 50:50.

The step of preparing the mixture may include a step of adding an amine-based catalyst to the mixture.

The step of forming the mixture in the form of a film may include steps of drying the mixture at a temperature of 70 to 90° C. for 1 to 5 hours and crosslinking the dried resulting product at a temperature of no to 130° C. for 15 to 25 hours.

According to embodiments of the present disclosure, it is possible to obtain a benzimidazole-based polymer electrolyte membrane having high ionic conductivity under high temperature and non-humidified conditions.

According to embodiments of the present disclosure, since the mechanical properties have been improved due to the formation of a cross-linked structure within the electrolyte membrane, and the phosphoric acid content has been increased by pores caused by the selective elution of only nanostructured materials containing imidazole groups during phosphoric acid impregnation, it is possible to obtain a polymer electrolyte membrane for high temperatures having higher mechanical strength and hydrogen ion conductivity than the conventional hydrocarbon-based polymer electrolyte membrane.

The effects of embodiments of the present disclosure are not limited to the above-mentioned effects. It should be understood that the effects of embodiments of the present disclosure include all effects that can be inferred from the following description.

### BRIEF DESCRIPTION OF THE DRAWINGS

FIG. 1 schematically shows the structure of a polymer electrolyte membrane according to embodiments of the present disclosure.

FIG. 2 is a graph of FT-IR analysis of PM films for each MDI content with respect to PBI.

FIG. 3 is a graph obtained by measuring the tensile strength of a polymer electrolyte membrane prepared in Preparation Example 1.

FIG. 4A shows the structure of an imidazole-based nanostructure (ZIF-8).

FIG. 4B is an FE-SEM photograph of an imidazole-based nanostructure (ZIF-8) powder.

FIG. 4C is a TEM photograph of the imidazole-based nanostructure (ZIF-8) powder.

FIGS. 5A and 5B are images taken by FE-SEM before and after impregnating phosphoric acid into a polymer film including the imidazole-based nanostructure (ZIF-8).

FIG. 6 schematically illustrates the structure of a polymer electrolyte membrane according to an Example.

FIG. 7 is a graph obtained by measuring the tensile strength of the polymer electrolyte membrane according to the Example.

The following reference identifiers may be used in connection with the accompanying drawings to describe exemplary embodiments of the present disclosure.
10: Benzimidazole-based polymer
20: Nanostructure
30: Crosslinking agent
100: Polymer electrolyte membrane

### DETAILED DESCRIPTION OF ILLUSTRATIVE EMBODIMENTS

The above objects, other objects, features, and advantages of embodiments of the present disclosure will be easily understood through the following preferred embodiments related to the accompanying drawings. However, the present disclosure is not limited to the embodiments described herein and may be embodied in other forms. Rather, the embodiments introduced herein are provided so that the disclosed content may become thorough and complete, and the spirit of embodiments of the present disclosure may be sufficiently conveyed to those skilled in the art.

The similar reference numerals have been used for similar elements while explaining each drawing. In the accompanying drawings, the dimensions of the structures are illustrated after being more enlarged than the actual dimensions for clarity of embodiments of the present disclosure. Terms such as first, second, etc. may be used to describe various components, but the components should not be limited by the terms. The terms are used only for the purpose of distinguishing one component from another component. For example, a first component may be referred to as a second component, and similarly, the second component may also be referred to as the first component, without departing from the scope of rights of the present disclosure. The singular expression includes the plural expression unless the context clearly dictates otherwise.

In the present specification, terms such as “comprise”, “have”, etc. are intended to designate that a feature, number, step, operation, component, part, or a combination thereof described in the specification exists, but it should be understood that the terms do not preclude the possibility of the existence or addition of one or more other features, numbers, steps, operations, components, parts, or combinations thereof. Further, when a part of a layer, film, region, plate, etc. is said to be “on” another part, this includes not only the case where it is “directly on” the other part, but also the case where there is another part in the middle therebetween. Conversely, when a part of a layer, film, region, plate, etc. is said to be “under” another part, this includes not only the case where it is “directly under” the other part, but also the case where there is another part in the middle therebetween.

Unless otherwise specified, since all numbers, values, and/or expressions expressing quantities of components, reaction conditions, polymer compositions, and formulations used in embodiments of the present specification are approximate values reflecting various uncertainties of the measurement that arise in obtaining these values among others in which these numbers are essentially different, they should be understood as being modified by the term “about” in all cases. Further, when a numerical range is disclosed in this description, such a range is continuous and includes all values from a minimum value of such a range to a maximum value including the minimum and maximum values, unless otherwise indicated. Furthermore, when such a range refers to an integer, all integers from the minimum value to the maximum value including the minimum and maximum values are included, unless otherwise indicated.

Embodiments of the present disclosure relate to a benzimidazole-based polymer electrolyte membrane having high ionic conductivity under high temperature and non-humidified conditions.

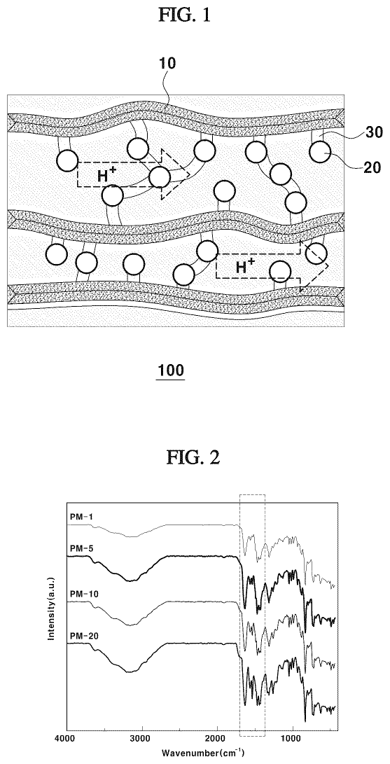

FIG. 1 schematically shows the structure of a polymer electrolyte membrane according to embodiments of the present disclosure.

Referring to FIG. 1, the polymer electrolyte membrane 100 according to embodiments of the present disclosure is prepared using a method for preparing a polymer electrolyte membrane, which will be described later, and is obtained by reacting a benzimidazole-based polymer 10, a nanostructure 20 containing an imidazole group, and a crosslinking agent 30 containing an isocyanate group.

The polymer electrolyte membrane 100 may be one in which an imidazole group in the benzimidazole-based polymer 10 and the imidazole group of the nanostructure 20 are crosslinked by the isocyanate group of the crosslinking agent 30.

The polymer electrolyte membrane loo may include urea crosslinking.

Specifically, the urea crosslinking present in the polymer electrolyte membrane 100 in embodiments of the present disclosure may be represented by Chemical Formula 1 below.

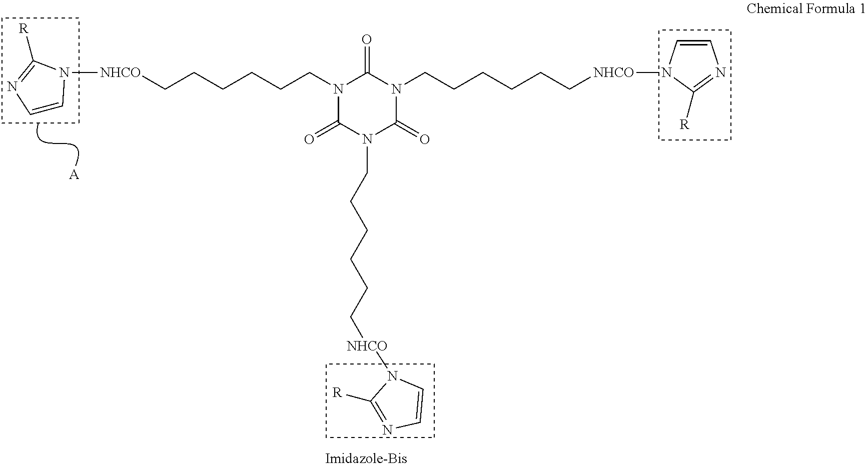

The benzimidazole-based polymer 10 may contain a benzimidazole group.

The benzimidazole-based polymer 10 may include at least one selected from the group consisting of poly[2,2′-(m-phenylene)-5,5′-bibenzimidazole] (PBI), poly(2,5-benzimidazole) (ABPBI), and a combination thereof.

The nanostructure 20 may contain an imidazole group.

The nanostructure 20 may be one in which any one selected from the group consisting of Zn, Co, Cu, Fe, and combinations thereof is connected to imidazole or an imidazole derivative.

The nanostructure 20 may have a particle size of 100 nm or less and may be a cube-shaped nanostructure.

Specifically, the nanostructure 20 may be a zeolitic imidazolate framework (ZIF).

The crosslinking agent 30 may contain an isocyanate group. The crosslinking agent 30 may have 2 to 4 functional groups (—N═C═O).

The crosslinking agent 30 may include any one selected from the group consisting of methylene diphenyl diisocyanate (MDI), hexamethylene diisocyanate (HDI), and a combination thereof.

The polymer electrolyte membrane 100 may further include an amine-based catalyst. The amine-based catalyst used in embodiments of the present disclosure is conventionally known and is not particularly limited. For example, the amine-based catalyst may include any one selected from triethylamine (TEA), tripropylamine, polyisopropanolamine, tributylamine, trioctylamine, hexamethyldimethylamine, N-methylmorpholine, N-ethylmorpholine, N-octadecylmorpholine, monoethanolamine, diethanolamine, triethanolamine, N-methyldiethanolamine, N,N-dimethylethanolamine, diethylenetriamine, N,N,N′,N′-tetramethylethylenediamine, N,N,N′,N′-tetramethylpropylenediamine, N,N,N′,N′-tetramethylbutanediamine, N,N,N′,N′-tetramethyl-1,3-butanediamine, N,N,N′,N′-tetramethylhexamethylenediamine, bis[2-(N,N-dimethylamino)ethyl] ether, N,N-dimethylbenzylamine, N,N-dimethylcyclohexylamine, N,N,N′,N″,N″′-pentamethyldiethylenetriamine, and triethylenediamine.

Another embodiment of the present disclosure relates to a fuel cell including the polymer electrolyte membrane. The fuel cell according to embodiments of the present disclosure includes the polymer electrolyte membrane, a cathode positioned on one surface of the polymer electrolyte membrane, and an anode positioned on the other surface of the polymer electrolyte membrane.

Still another embodiment of the present disclosure relates to a method for preparing a polymer electrolyte membrane.

The method for preparing a polymer electrolyte membrane according to embodiments of the present disclosure includes steps of preparing a nanostructure containing an imidazole group, mixing a benzimidazole-based polymer, the nanostructure, and a crosslinking agent containing an isocyanate group to prepare a mixture, and forming the mixture in the form of a film.

First, in the step of preparing the nanostructure, a compound containing any one selected from the group consisting of imidazole or an imidazole derivative, Zn, Co, Cu, Fe, and combinations thereof and a solvent may be mixed and then dried to obtain the nanostructure.

Here, the nanostructure may have a particle size of 100 nm or less. Preferably, a zeolitic imidazolate framework (ZIF) may be used as the nanostructure.

Subsequently, in the step of preparing the mixture, the benzimidazole-based polymer, the nanostructure, and the crosslinking agent may be mixed.

At this time, in the step of preparing the mixture, the benzimidazole-based polymer and the crosslinking agent may be mixed at a weight ratio of 100:0 to 50:50.

Preferably, the crosslinking agent may be used in an amount of 20% by weight or less based on 100% by weight of the mixture in which the benzimidazole-based polymer and the crosslinking agent are mixed.

At this time, when the crosslinking agent is used in an amount exceeding 20% by weight, there is a problem in that an agglomeration phenomenon occurs due to its own binding, which hinders film formation.

The benzimidazole-based polymer may include at least one selected from the group consisting of poly[2,2′-(m-phenylene)-5,5′-bibenzimidazole] (PBI), poly(2,5-benzimidazole) (ABPBI), and a combination thereof.

The crosslinking agent may include any one selected from the group consisting of methylene diphenyl diisocyanate (MDI), hexamethylene diisocyanate (HDI), and a combination thereof.

In addition, in the step of preparing the mixture, the benzimidazole-based polymer and the nanostructure may be mixed at a weight ratio of 100:0 to 50:50.

Preferably, the nanostructure may be used in an amount of 10% by weight or less based on 100% by weight of the mixture in which the benzimidazole-based polymer and the nanostructure are mixed.

At this time, when the nanostructure is used in an amount exceeding 10% by weight, there is a problem in that excessive pores are formed, which hinders the formation of the final resulting product, the film.

In addition, an amine-based catalyst may be additionally added to the mixture in the step of preparing the mixture. The amine-based catalyst is conventionally known and is not particularly limited. For example, the amine-based catalyst may include any one selected from triethylamine (TEA), tripropylamine, polyisopropanolamine, tributylamine, trioctylamine, hexamethyldimethylamine, N-methylmorpholine, N-ethylmorpholine, N-octadecylmorpholine, monoethanolamine, diethanolamine, triethanolamine, N-methyldiethanolamine, N,N-dimethylethanolamine, diethylenetriamine, N,N,N′,N′-tetramethylethylenediamine, N,N,N′,N′-tetramethylpropylenediamine, N,N,N′,N′-tetramethylbutanediamine, N,N,N′,N′-tetramethyl-1,3-butanediamine, N,N,N′,N′-tetramethylhexamethylenediamine, bis[2-(N,N-dimethylamino)ethyl] ether, N,N-dimethylbenzylamine, N,N-dimethylcyclohexylamine, N,N,N′,N″,N″′-pentamethyldiethylenetriamine, and triethylenediamine.

Finally, in the step of forming the mixture in the form of a film, a drying step and a crosslinking step may be performed.

In the drying step, drying of the mixture may be performed at a temperature of 70 to 90° C. for 1 to 5 hours. In addition, in the crosslinking step, crosslinking of the dried resulting product may be performed at a temperature of no to 130° C. for 15 to 25 hours.

Hereinafter, the present disclosure will be described in more detail through specific examples. The following examples are merely examples to aid understanding of embodiments of the present disclosure, and the scope of the embodiments of the present disclosure is not limited thereto.

### Preparation Example 1 (Synthesis of Benzimidazole-based Polymer and Crosslinking Agent)

First, in order to examine the structure in the polymer electrolyte membrane through the reaction of the benzimidazole-based polymer and the crosslinking agent, a polymer electrolyte membrane was prepared through the following method.

5 g of a solution in which 10% by weight of a benzimidazole-based polymer was dissolved in an organic solvent, 0.5 g of a solution in which 10% by weight of a crosslinking agent was dissolved in an organic solvent, and a catalyst were stirred at room temperature for 3 hours. Subsequently, the stirred solution was cast, dried at 80° C. for 3 hours, and heat-treated at 120° C. for 21 hours to prepare a polymer film through a crosslinking process. At this time, poly[2,2′-(m-phenylene)-5,5′-bibenzimidazole] (PBI) was used as the benzimidazole-based polymer, and methylene diphenyl diisocyanate (MDI) was used as the crosslinking agent, dimethylacetamide (DMAc) was used as the organic solvent, and triethylamine (TEA) was used as the catalyst.

Subsequently, the prepared polymer film was washed several times with distilled water and then dried again to finally prepare a crosslinked polymer electrolyte membrane (PM-10). Here, X means % by weight of MDI with respect to PBI.

Specifically, the polymer electrolyte membrane (PM-10) prepared in Preparation Example 1 may be synthesized as shown in Reaction Formula 1 below.

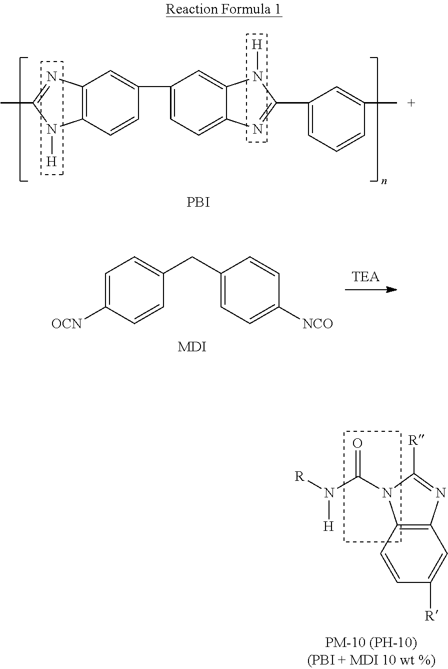

Referring to Reaction Formula 1, a crosslinking agent (MDI) in Preparation Example 1 contains two —NCO functional groups at both ends along with two aromatic rings in the crosslinking agent, and thus the functional groups may induce urea bonding with an imidazole group in the benzimidazole-based polymer (PBI).

Subsequently, in order to find the optimal ratio of the polymer electrolyte membrane (PM-10) according to Preparation Example 1, an examination of the degree of crosslinking for each MDI content was performed. At this time, the weight ratio of the PBI and the MDI was adjusted from 100:0 to 80:20 to prepare each solution.

Specifically, the content of the MDI relative to the PBI was adjusted to 1% by weight (PM-1), 5% by weight (PM-5), 10% by weight (PM-10), or 20% by weight (PM-20). Subsequently, each prepared solution was subjected to infrared spectroscopy to confirm the degree of crosslinking.

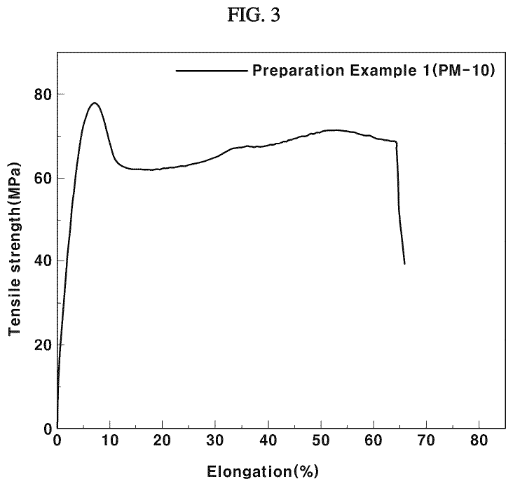

FIG. 2 is a graph of FT-IR analysis of PM films for each MDI content with respect to the PBI. Referring to FIG. 2, it can be confirmed that the peak size (1,490 to 1,465 cm-1) of urea bonds (—N—C—N—) increases as the content of the MDI compared to the PBI increases. Therefore, it can be confirmed that the degree of crosslinking increases as the content of the MDI compared to the PBI increases.

Subsequently, in order to grasp the mechanical strength of the polymer electrolyte membrane (PM-10) prepared in Preparation Example 1 according to the content of the crosslinking agent, a characteristic survey was conducted through a universal material testing machine, and the results are shown in FIG. 3 and Table 1 below. Here, the size of the specimen follows the standard of ASTM D638 Type V, and the characteristic survey proceeds under the conditions of crosshead speed of 10 mm/min, room temperature (23±2° C.), and RH 50±5%.

FIG. 3 is a graph obtained by measuring the tensile strength of a polymer electrolyte membrane prepared in Preparation Example 1.

Referring to FIG. 3 and Table 1, the tensile strength of the polymer electrolyte membrane (PM-10) was measured to be 77.5 MPa, and the elongation thereof was measured to be 65%.

TABLE 1

| Classification | Tensile strength (MPa) | Elongation (%) |
|---|---|---|
| Preparation Example 1 | 77.5 | 65 |
| (PM-10) | | |

Therefore, it was confirmed that the polymer film according to Preparation Example 1 exhibited a tendency for mechanical strength to increase and elongation to decrease as the content of the crosslinking agent increased. This is usually followed by an increase in bond strength and a decrease in elongation as the polymer is crosslinked, and this means a phenomenon that the mechanical strength does not significantly increase even when the crosslinking agent content exceeds 10% by weight and becomes 20% by weight.

Therefore, as the amount of crosslinking increases, the decrease in hydrogen ion conductivity can be expected, and thus the optimal MDI content was determined to be 10% by weight.

Subsequently, the hydrogen ion conductivity of the polymer electrolyte membrane (PM-10) according to Preparation Example 1 was confirmed, and the hydrogen ion conductivity of the polymer electrolyte membrane (PM-10) was measured and is shown in Table 2 below. The hydrogen ion conductivity was measured by impregnating the polymer electrolyte membrane with 85% by weight of a phosphoric acid aqueous solution at 80° C. for 4 hours and then drying it at room temperature in a vacuum oven for 24 hours. Thereafter, the polymer electrolyte membrane swollen due to phosphoric acid was fastened to a 4-point probe cell, and then the resistance values were measured in a nitrogen atmosphere at 120° C. and 150° C.

TABLE 2

| | Phosphoric acid | | Hydrogen ion |
|---|---|---|---|
| | content | Resistance | conductivity |
| | after doping | (120° C./ | (120° C./ |
| Classification | (% by weight) | 150° C., Ω) | 150° C., S/cm) |
| Preparation | 79 | 761 / 670 | 0.069 / 0.079 |
| Example 1 | | | |
| (PM-10) | | | |

Referring to Table 2, the polymer electrolyte membrane (PM-10) had a phosphoric acid content after doping of 79% by weight. In addition, the polymer electrolyte membrane (PM-10) had resistance values of 761Ω at 120° C. and 670Ω at 150° C. In addition, the polymer electrolyte membrane (PM-10) had hydrogen ion conductivity values of 0.069 S/cm at 120° C. and 0.079 S/cm at 150° C.

### Preparation Example 2 (Synthesis of Imidazole-Based Nanostructure)

Subsequently, an imidazole-based nanostructure according to embodiments of the present disclosure was synthesized through the following method. Specifically, in the synthesis method, 2.94 g of zinc nitrate hexahydrate and 3.24 g of imidazole were each dissolved in 200 ml of methanol. Subsequently, after complete dissolution, a low-temperature atmosphere was formed using an ice bath, and then a solution in which zinc nitrate hexahydrate was dissolved was mixed with a solution in which imidazole was dissolved and stirred. Subsequently, after leaving the stirred solution alone at room temperature for 24 hours, the stirred solution was washed with methanol three times and then dried at 60° C. for one day to prepare a zinc nitrate hexahydrate and imidazole (ZIF-8) powder.

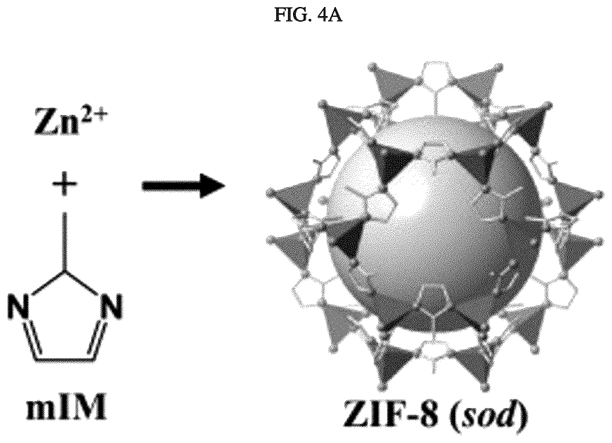

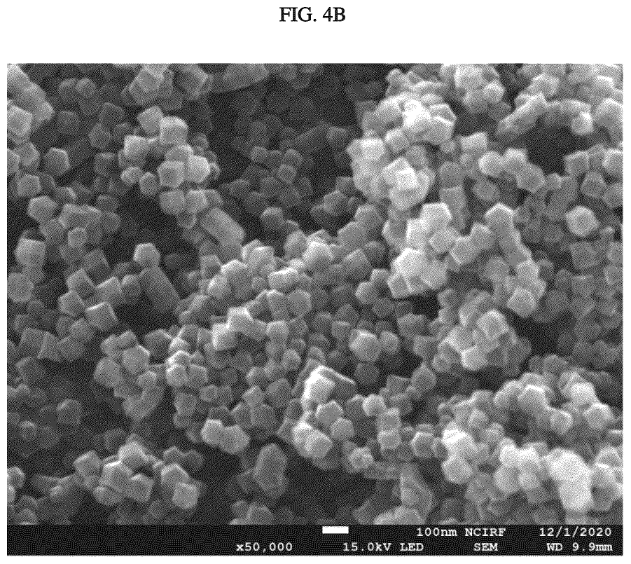

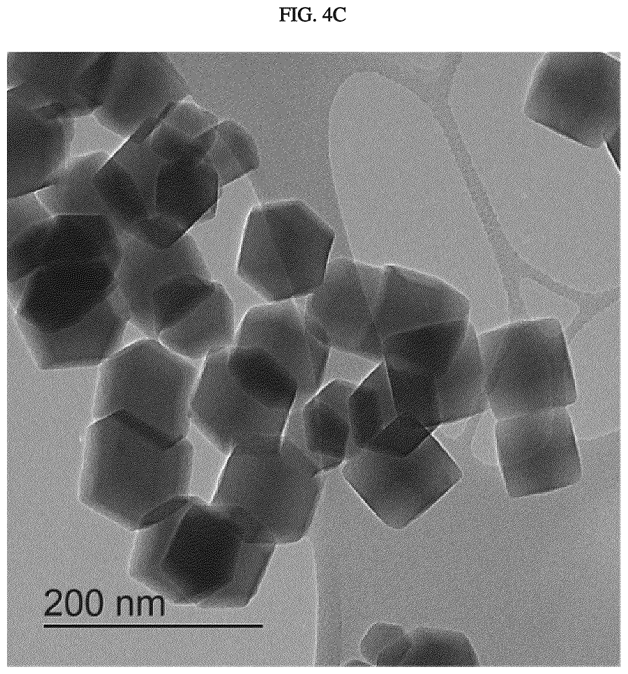

Referring to FIGS. 4A, 4B, and 4C, it can be confirmed that the synthesized imidazole-based nanostructure has a particle size of 100 nm or less.

Here, FIG. 4A shows the structure of an imidazole-based nanostructure (ZIF-8), FIG. 4B is an FE-SEM photograph of an imidazole-based nanostructure (ZIF-8) powder, and FIG. 4C is a TEM photograph of the imidazole-based nanostructure (ZIF-8) powder.

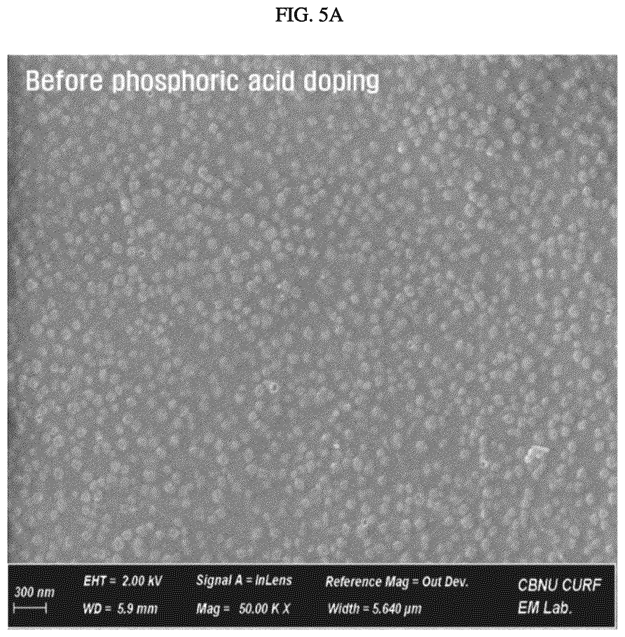

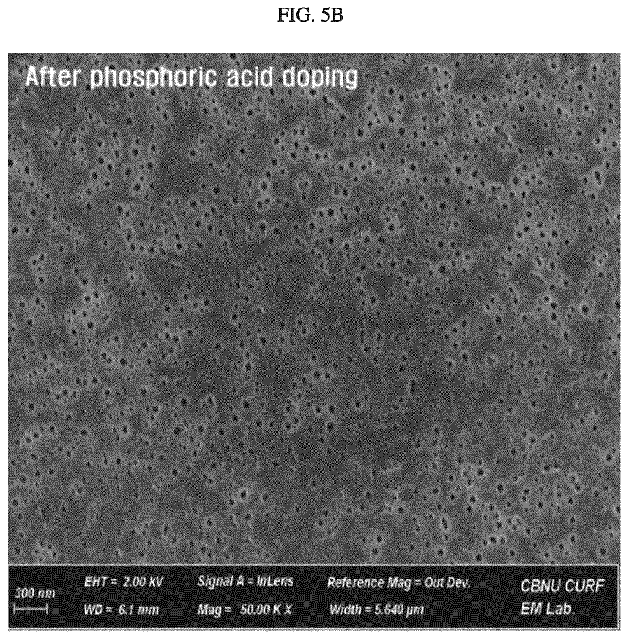

Referring to FIGS. 5A and 5B, characteristics that the synthesized imidazole-based nanostructure has its structure disintegrated by acid can be confirmed.

Here, FIG. 5A is an image obtained by photographing the appearance of a polymer film including an imidazole-based nanostructure (ZIF-8) before being impregnated with phosphoric acid using FE-SEM. And, FIG. 5B is an image obtained by photographing the appearance of a polymer film including the imidazole-based nanostructure (ZIF-8) after being impregnated with phosphoric acid using FE-SEM.

Therefore, when the imidazole-based nanostructure and the PBI are used together in the polymer electrolyte membrane, the phosphoric acid content may be increased by forming nanopores in the polymer electrolyte membrane since the imidazole-based nanostructure is eluted in the impregnated phosphoric acid.

### Example (Polymer Electrolyte Membrane to Which PMZ-8, PBI, and MDI are Applied)

Next, a polymer electrolyte membrane according to an Example of embodiments of the present disclosure was prepared through the following method.

First, 5 g of a solution in which 10% by weight of a benzimidazole-based polymer was dissolved in an organic solvent, 0.5 g of a solution in which a 10% by weight of a crosslinking agent was dissolved in the organic solvent, 0.15 g of a solution in which 10% by weight of an imidazole-based nanostructure was dissolved in the organic solvent, and about 1 mL of a catalyst were put into a vial and stirred at room temperature for 3 hours. Subsequently, after the stirred solution was cast, it was dried at 80° C. for 3 hours, and then heat-treated at 120° C. for 21 hours to prepare a polymer film through a crosslinking process. At this time, poly[2,2′-(m-phenylene)-5,5′-bibenzimidazole] (PBI) was used as the benzimidazole-based polymer, methylene diphenyl diisocyanate (MDI) was used as the crosslinking agent, dimethylacetamide (DMAc) was used as the organic solvent, a zinc nitrate hexahydrate and imidazole (ZIF-8) was used as the imidazole-based nanostructure, and triethylamine (TEA) was used as the catalyst.

Subsequently, the prepared polymer film was washed several times with distilled water and then dried again to finally prepare a crosslinked polymer electrolyte membrane.

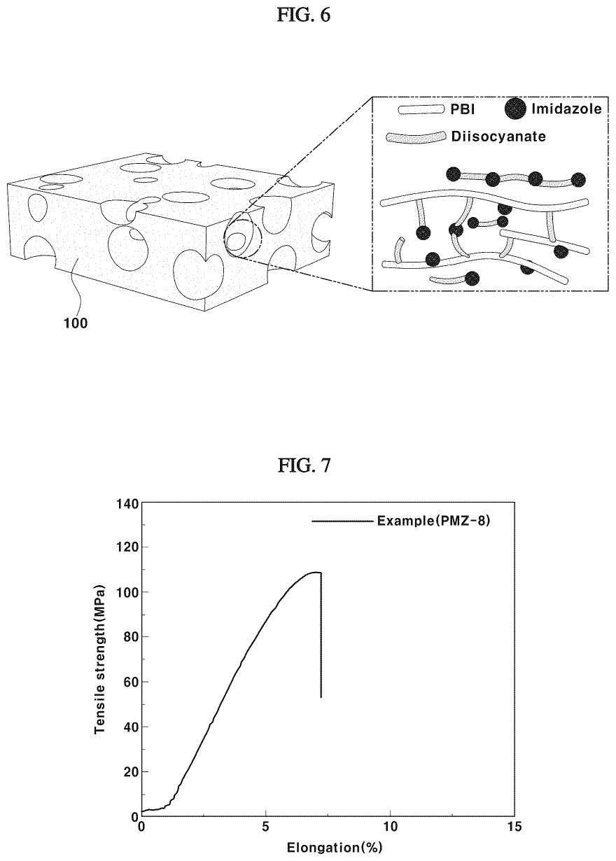

FIG. 6 schematically illustrates the structure of a polymer electrolyte membrane according to an Example. This figure provides a proposal for a final resulting product chemical structure (cross-linked porous PBI electrolyte membrane).

Referring to FIG. 6, in the polymer electrolyte membrane 100 according to the Example, since the imidazole-based nanostructure (ZIF-8) includes an imidazole functional group together with a benzimidazole-based polymer (PBI), urea bonding is possible with a crosslinking agent (MDI).

In addition, as shown in FIG. 6, the imidazole-based nanostructure (ZIF-8) may have its structure collapsed and eluted by phosphoric acid to form nanopores on the inside and surface of the benzimidazole-based polymer (PBI).

Therefore, finally, in the structure of the polymer electrolyte membrane according to the Example of embodiments of the present disclosure, the imidazole group in the benzimidazole-based polymer (PBI) and the imidazole group derived from the imidazole-based nanostructure (ZIF-8) are bonded by a crosslinking agent (MDI), and the places where the shape of the nanocube structure of the imidazole group and the imidazole-based nanostructure (ZIF-8) had been present remain as pores due to elution during the phosphoric acid impregnation process.

Subsequently, in order to grasp the mechanical strength of the polymer electrolyte membrane according to the Example, a characteristic survey was conducted through a universal material testing machine, and the results are shown in FIG. 7 and Table 3 below. Here, the size of the specimen follows the standard of ASTM D638 Type V, and the characteristic survey proceeds under the conditions of crosshead speed of 10 mm/min and room temperature (23±2° C.), and RH 50±5%.

TABLE 3

| | Tensile strength (MPa) | Elongation (%) |
|---|---|---|
| Example | 107.7 | 7 |
| (PMZ-8) | | |

FIG. 7 is a graph obtained by measuring the tensile strength of the polymer electrolyte membrane according to the Example.

Referring to FIG. 7 and Table 3, the tensile strength of the polymer electrolyte membrane according to the Example was measured to be 107.7 MPa, and the elongation thereof was measured to be 7%.

Subsequently, in order to confirm the hydrogen ion conductivity of the polymer electrolyte membrane according to the Example, the hydrogen ion conductivity of the polymer electrolyte membrane according to Example was measured and is shown in Table 4 below. The hydrogen ion conductivity was measured by impregnating the polymer electrolyte membrane with 85% by weight of a phosphoric acid aqueous solution at 80° C. for 4 hours and then drying it at room temperature in a vacuum oven for 24 hours. Thereafter, the polymer electrolyte membrane swollen due to phosphoric acid was fastened to a 4-point probe cell, and then the resistance values were measured in a nitrogen atmosphere at 120° C. and 150° C.

TABLE 4

| | Phosphoric acid | | Hydrogen ion |
|---|---|---|---|
| | content | Resistance | conductivity |
| | after doping | (120° C./ | (120° C./ |
| Classification | (% by weight) | 150° C., Ω) | 150° C., S/cm) |
| Example | 83 | 689 / 507 | 0.035 / 0.047 |
| (PMZ-8) | | | |

Referring to Table 4, the polymer electrolyte membrane according to the Example had a phosphoric acid content after doping of 88% by weight. In addition, the polymer electrolyte membrane according to the Example had resistance values of 689Ω at 120° C. and 507Ω at 150° C. In addition, the polymer electrolyte membrane according to the Example had hydrogen ion conductivity values of 0.035 S/cm at 120° C. and 0.047 S/cm at 150° C.

On the other hand, in the conventional polymer electrolyte membrane, moisture management during operation is very important. In the conventional polymer electrolyte membrane, the number of water molecules decreases due to dehydration during operation at a high temperature of 100° C. or higher, and accordingly, conductivity tends to decrease as dissociation of ion pairs becomes difficult.

In addition, in the case of conventional hydrocarbon-based polymer electrolyte membranes, materials having aromatic rings are mainly used for durability, but due to the bulky aromatic rings, the spacing between chains is narrow, making it difficult to form large ion transport channels.

In addition, in conventional hydrocarbon-based polymer electrolyte membranes containing phosphoric acid, hydrogen ion conductivity decreases when the content of phosphoric acid responsible for hydrogen ion conduction is low, whereas mechanical properties of the electrolyte membranes deteriorate when the content of phosphoric acid is high.

On the other hand, in embodiments of the present disclosure, mechanical stability can be expected during phosphoric acid impregnation under high temperature conditions by increasing the mechanical strength of the polymer film through crosslinking of the benzimidazole-based polymer chains. In addition, since the imidazole-based nanostructure contains an imidazole group, there is an effect of widening the crosslinking region. In addition, the imidazole-based nanostructure serves as a porogen by utilizing the characteristic of being eluted when impregnated with phosphoric acid and can help high phosphoric acid impregnation by expanding the surface and internal area of the polymer film with pores formed through this.

Therefore, according to embodiments of the present disclosure, it is possible to obtain a benzimidazole-based polymer electrolyte membrane having high ionic conductivity under high temperature and non-humidified conditions.

In addition, according to embodiments of the present disclosure, the mechanical properties are improved due to the formation of a crosslinked structure in the electrolyte membrane, and since the phosphoric acid content is increased by the pores formed as only the nanostructured material containing an imidazole group is selectively eluted when impregnated with phosphoric acid, a polymer electrolyte membrane for high temperatures having high mechanical strength and hydrogen ion conductivity compared to the conventional hydrocarbon-based polymer electrolyte membranes can be obtained.

Although embodiments of the present disclosure have been described with reference to the accompanying drawings, it will be understood that those skilled in the art to which the present disclosure pertains can implement embodiments of the present disclosure in other specific forms without changing the technical spirit or essential features of embodiments of the present disclosure. Therefore, it should be understood that the embodiments described above are illustrative in all aspects and not restrictive.

What is claimed is:

1. A method for preparing a polymer electrolyte membrane, the method comprising:
preparing a nanostructure comprising an imidazole group;
mixing a benzimidazole-based polymer, the nanostructure, and a crosslinking agent comprising an isocyanate group to prepare a mixture; and
forming the mixture into a film.

2. The method of claim 1, further comprising drying the mixture after mixing a compound comprising a material selected from the group consisting of imidazole, an imidazole derivative, Zn, Co, Cu, and Fe, and combinations thereof, and a solvent.

3. The method of claim 1, wherein the nanostructure comprises a zeolitic imidazolate framework (ZIF) having a particle size of loo nm or less.

4. The method of claim 1, wherein the benzimidazole-based polymer and the crosslinking agent are mixed at a weight ratio of 100:0 to 50:50.

5. The method of claim 1, wherein the benzimidazole-based polymer comprises poly[2,2′-(m-phenylene)-5,5′-bibenzimidazole] (PBI) or poly(2,5-benzimidazole) (ABPBI).

6. The method of claim 1, wherein the crosslinking agent comprises methylene diphenyl diisocyanate (MDI) or hexamethylene diisocyanate (HDI).

7. The method of claim 1, wherein the benzimidazole-based polymer and the nanostructure are mixed at a weight ratio of 100:0 to 50:50.

8. The method of claim 1, the mixing comprises adding an amine-based catalyst to the mixture.

9. The method of claim 1, wherein forming the mixture into the film comprises:
drying the mixture at a temperature of 70° C. to 90° C. for 1 to 5 hours; and
crosslinking the dried resulting product at a temperature of 110° C. to 130° C. for 15 to 25 hours.

10. A polymer electrolyte membrane obtained by reacting a benzimidazole-based polymer, a nanostructure containing an imidazole group, and a crosslinking agent containing an isocyanate group.

11. The polymer electrolyte membrane of claim 10, wherein an imidazole group in the benzimidazole-based polymer and the imidazole group in the nanostructure are crosslinked by the isocyanate group.

12. The polymer electrolyte membrane of claim 10, wherein the polymer electrolyte membrane comprises urea crosslinking.

13. The polymer electrolyte membrane of claim 10, wherein the benzimidazole-based polymer comprises poly[2,2′-(m-phenylene)-5,5′-bibenzimidazole] (PBI) or poly(2,5-benzimidazole) (ABPBI).

14. The polymer electrolyte membrane of claim 10, wherein the nanostructure comprises an element selected from the group consisting of Zn, Co, Cu, and Fe, and combinations thereof, the element being connected to imidazole or an imidazole derivative.

15. The polymer electrolyte membrane of claim 10, wherein the nanostructure comprises a zeolitic imidazolate framework (ZIF) having a particle size of 100 nm or less.

16. The polymer electrolyte membrane of claim 10, wherein the crosslinking agent comprises methylene diphenyl diisocyanate (MDI) or hexamethylene diisocyanate (HDI).

17. The polymer electrolyte membrane of claim 10, wherein the crosslinking agent has 2 to 4 functional groups.

18. The polymer electrolyte membrane of claim 10, wherein the polymer electrolyte membrane further comprises an amine-based catalyst.

19. The polymer electrolyte membrane of claim 18, wherein the amine-based catalyst comprises a catalyst selected from the group consisting of triethylamine (TEA), tripropylamine, polyisopropanolamine, tributylamine, trioctylamine, hexamethyldimethylamine, N-methylmorpholine, N-ethylmorpholine, N-octadecylmorpholine, monoethanolamine, diethanolamine, triethanolamine, N-methyldiethanolamine, N,N-dimethylethanolamine, diethylenetriamine, N,N,N′,N′-tetramethylethylenediamine, N,N,N′,N′-tetramethylpropylenediamine, N,N,N′,N′-tetramethylbutanediamine, N,N,N′,N′-tetramethyl-1,3-butanediamine, N,N,N′,N′-tetramethylhexamethylenediamine, bis[2-(N,N-dimethylamino)ethyl] ether, N,N-dimethylbenzylamine, N,N-dimethylcyclohexylamine, N,N,N′,N″,N″′-pentamethyldiethylenetriamine, and triethylenediamine.

20. A fuel cell comprising:
a polymer electrolyte membrane comprising a reaction product of a benzimidazole-based polymer, a nanostructure comprising an imidazole group, and a crosslinking agent comprising an isocyanate group;
a cathode on a first surface of the polymer electrolyte membrane; and
an anode on a second surface of the polymer electrolyte membrane opposite the first surface.
